(19) United States
(12) Patent Application Publication
(10) Pub. No.: US 2018/0345200 A1
(43) Pub. Date: Dec. 6, 2018

(54) FILTER CYLINDER HAVING DUST CLEANING DEVICE OF DUST COLLECTOR

(71) Applicant: SAN FORD MACHINERY CO., LTD., Taichung (TW)

(72) Inventor: Yuan-Tai CHENG, TAICHUNG (TW)

(21) Appl. No.: 15/607,866

(22) Filed: May 30, 2017

(51) Int. Cl. B01D 46/24

(52) U.S. Cl. CPC B01D 46/2403; B01D 46/10

(57) ABSTRACT

A filter cylinder having a dust cleaning device of a dust collector is provided. The filter cylinder has a cylindrical outer frame. An HEPA filter is provided inside the filter cylinder. The inner wall of the filter is provided with a plurality of tabs arranged annularly. A cleaning device is disposed in the filter cylinder. The cleaning device includes a bracket. Two ends of the bracket are each provided with a flap member. The cleaning device is rotatable in the filter cylinder, with the flap member to flap the tab and further to vibrate the filter, so that the dust adsorbed to the filter drops from the filter to enhance the structural strength of the filter and to prolong the service life of the filter.

### FIELD OF THE INVENTION

The present invention relates to a dust collector, and more particularly to a filter cylinder having a dust cleaning device of a dust collector.

### BACKGROUND OF THE INVENTION

In the workplace where chips or dust are prone to occur, such as a woodworking plant, there is usually a dust collector used for maintaining the quality of the air and cleaning the environment. The dust collector collects chips and dust in the workplace to avoid chips and dust flying in the air so as to ensure the safety of the workplace and to facilitate the follow-up cleaning.

Referring to FIG. 1, a conventional dust collector includes a main body 1, a dust collection cylinder 2, and a filter cylinder 3. A filter 4 is provided in the filter cylinder 3. An exhauster 5 is disposed above the main body 1. The airflow with dust is sucked into the main body 1 through the exhauster 5. The heavy dust falls into the dust collection cylinder 2 due to gravity. The light dust is sucked to the filter 3 through the exhauster 5. A guide rod 6 and a flap member 7 are provided in the filter cylinder 3. The top of the guide rod 6 is provided with a handle 8. Through the handle 8, the guide rod 6 and the flap member 7 are driven to rotate in the filter cylinder 3, so that one end of the flap member 7 can flap the filter 4, thereby cleaning the filter cylinder 3 quickly.

However, the above-mentioned conventional filter 4 is a High-Efficiency Particulate Air (HEPA) filter, which is capable of filtering dust of PM2.5. A filtration film is attached to the inner wall of the filter 4. When the flap member 7 is rapidly rotated to flap the filter 4, the filtration film on the inner wall of the filter 4 is liable to be damaged and the filtering effect of the filter 4 is lowered. As a result, the service life of the filter 4 is shortened. Accordingly, the inventor of the present invention has devoted himself based on his many years of practical experiences to solve these problems.

### SUMMARY OF THE INVENTION

The primary object of the present invention is to provide a filter cylinder having a dust cleaning device of a dust collector to enhance the structural strength of a filter and to protect a filtration film on the inner wall of the filter.

In order to achieve the aforesaid object, a filter cylinder having a dust cleaning device of a dust collector is provided. The dust collector includes the filter cylinder. The filter cylinder has a cylindrical outer frame. A high-efficiency particulate air (HEPA) filter is provided inside the filter cylinder. The filter is in the form of a cylinder. An outer peripheral wall of the filter is formed with a plurality of zigzag edges. An inner peripheral wall of the filter is formed with zigzag tips corresponding to the zigzag edges. A cleaning device is axially provided in the filter cylinder. The cleaning device includes a main shaft. The main shaft is transversely provided with at least one bracket. Two ends of the bracket are each provided with a flap member. An upper end of the main shaft is provided with a handle. The cleaning device is driven to rotate in the filter cylinder by the handle. At least one tab is disposed in the filter cylinder. One end of the tab has a fixed portion fixed to a corresponding one of the zigzag tips of the filter. Another end of the tab has a movable portion extending toward the flap member to be in contact with the flap member.

When the flap member is rotated, one end of the flap member flaps the movable portion of the tab to vibrate the filter so that the dust adsorbed to the filter drops from the filter to enhance the structural strength of the filter and to protect the filtration film on the inner wall of the filter and to prolong the service life of the filter.

### BRIEF DESCRIPTION OF THE DRAWINGS

FIG. 1 is a front view of a conventional dust collector;

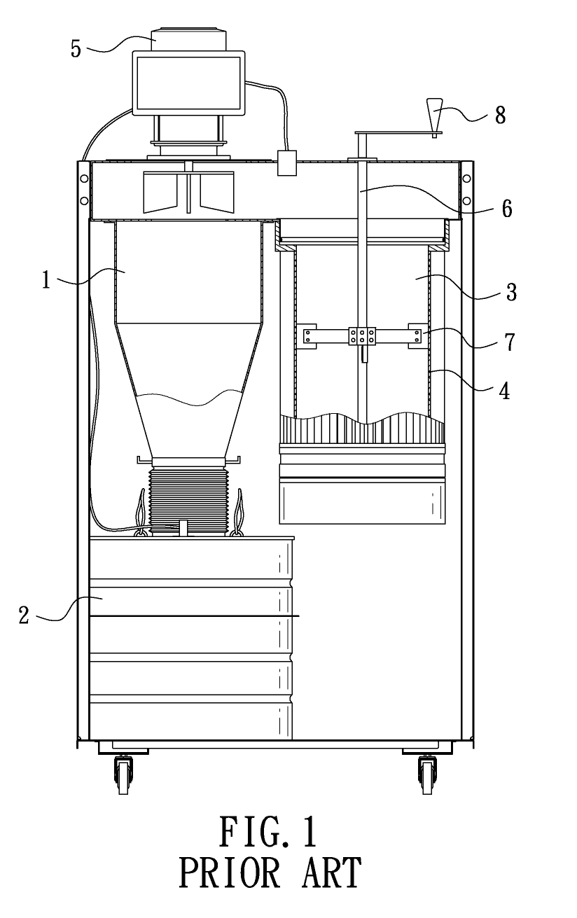

FIG. 2 is a perspective view in accordance with a preferred embodiment of the present invention;

FIG. 3 is a front view in accordance with the preferred embodiment of the present invention;

FIG. 4 is a perspective view of the filter cylinder and the cleaning device in accordance with a first embodiment of the present invention;

FIG. 5 is an exploded view of the filter cylinder and the cleaning device in accordance with the first embodiment of the present invention;

FIG. 6 is a sectional view of the filter cylinder and the cleaning device in accordance with the first embodiment of the present invention;

FIG. 7 is a top view of the filter cylinder and the cleaning device in accordance with the first embodiment of the present invention;

FIG. 8 is a partial enlarged view of the filter cylinder and the cleaning device in accordance with the first embodiment of the present invention;

FIG. 9 is a perspective view of the filter cylinder and the cleaning device in accordance with a second embodiment of the present invention; and

FIG. 10 is a sectional view of the filter cylinder and the cleaning device in accordance with the second embodiment of the present invention.

### DETAILED DESCRIPTION OF THE PREFERRED EMBODIMENTS

Embodiments of the present invention will now be described, by way of example only, with reference to the accompanying drawings.

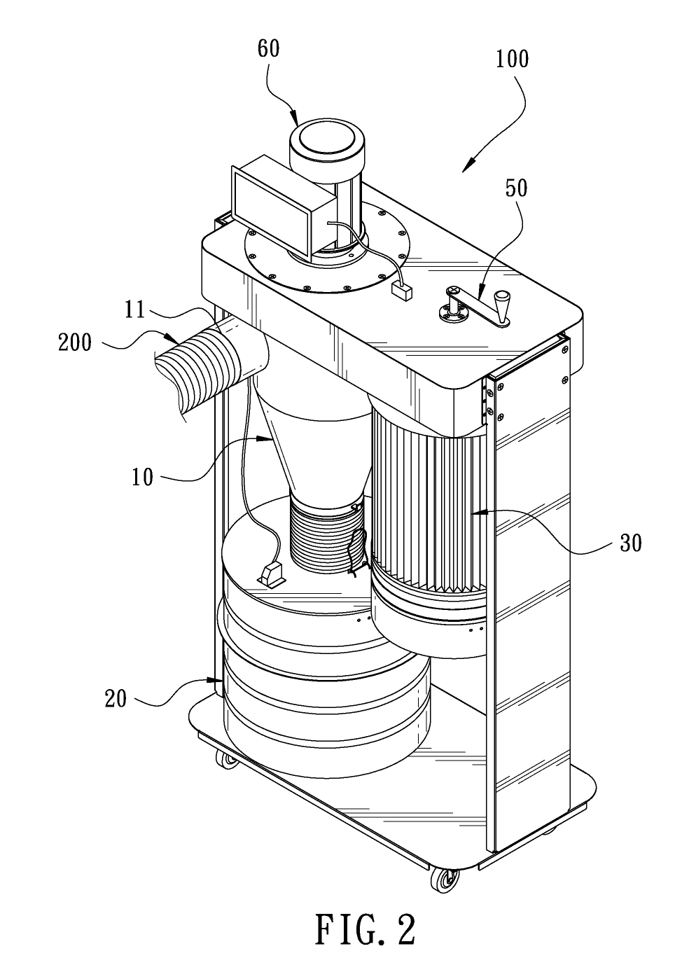

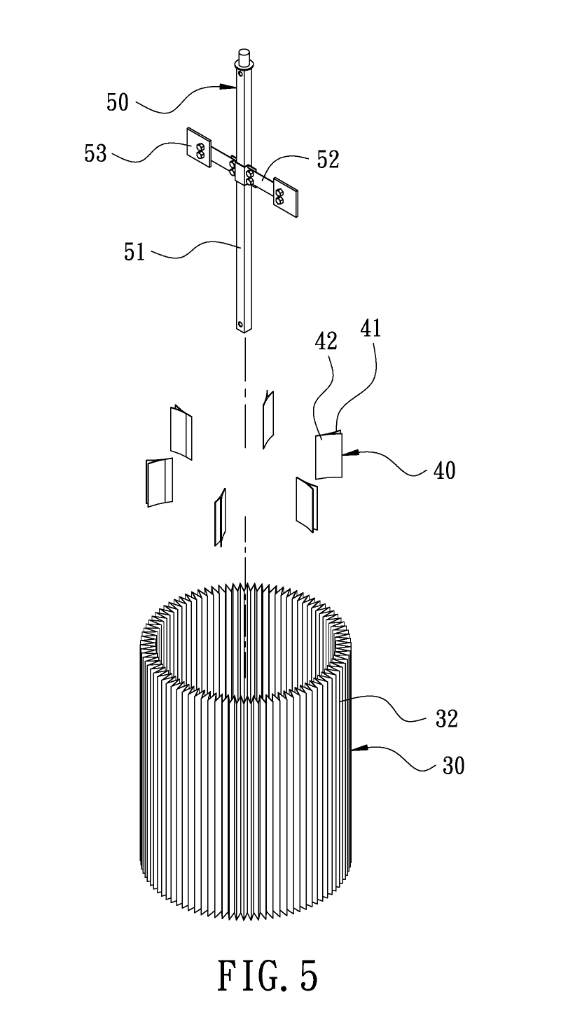

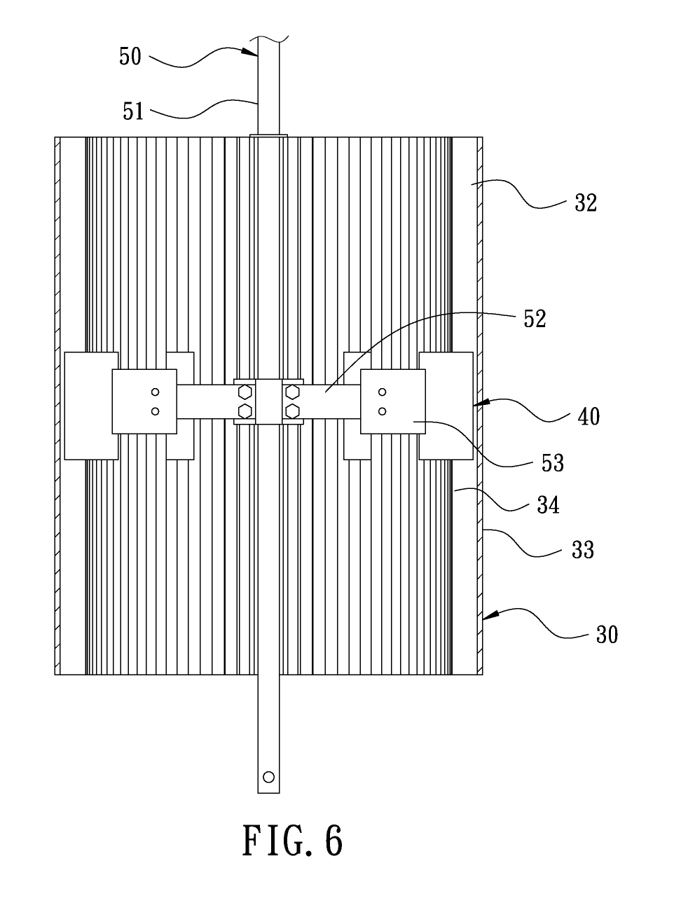

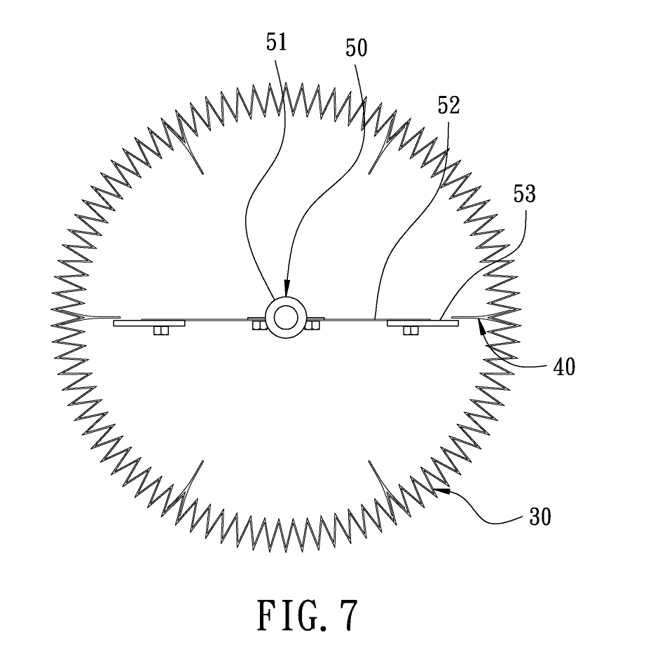

As shown in FIG. 2 to FIG. 8, the present invention discloses a filter cylinder having a dust cleaning device of a dust collector. A dust collector 100 comprises a main body 10, a dust collection cylinder 20, a filter cylinder 30, at least one tab 40, a cleaning device 50, and an exhauster 60.

The outer circumferential wall of the main body 10 is provided with an air inlet 11. The air inlet 11 is connected with a dust collection tube 200 for allowing dust to enter the main body 10. Both ends of the main body 10 are formed with a first air outlet 12 and a second air outlet 13, respectively.

The dust collection cylinder 20 is connected with the first air outlet 11 of the main body 10 for storing dust falling from the man body 10.

The filter cylinder 30 is connected with the second air outlet 13 of the main body 10. The filter cylinder 30 has a cylindrical outer frame 31. A filter 32 is provided inside the filter cylinder 30. The filter 32 is a high-efficiency particulate air (HEPA) filter. A filtration film is attached to the inner wall of the filter 32. The filter 32 is capable of filtering out dust of PM2.5. The filter 32 is in the form of a cylinder. An outer peripheral wall of the filter 32 is formed with a plurality of zigzag edges 33, and an inner peripheral wall of the filter 32 is formed with zigzag tips 34 corresponding to the zigzag edges 33, thereby enhancing the effect of filtering dust.

The tab 40 has a fixed portion 41 at one end thereof. The fixed portion 41 is fixed to a corresponding one of the zigzag tips 34 of the filter 32. The fixed portion 41 has a Y-like shape for the fixed portion 41 to be fixed to a corresponding one of the zigzag tips 34 of the filter 32. Another end of the tab 40 has a movable portion 42 extending toward the center of the filter cylinder 30. The fixed portion 41 is fixed to a corresponding one of the zigzag tips 34 of the filter 32 by bonding.

The cleaning device 50 is disposed in the filter cylinder 30. The cleaning device 50 is located at the center of the filter cylinder 30. The cleaning device 50 includes a guide rod 51 and at least one bracket 52. The bracket 52 is transversely disposed on the guide rod 51. Two ends of the bracket 52 are each provided with a flap member 53. One side of the flap member 53 corresponds to the tab 40. The cleaning device 50 further includes a handle 54. The handle 54 is fixedly disposed on the top of the guide rod 51.

The exhauster 60 is disposed above the main body 10. The exhauster 60 includes a motor 61. The motor 61 is connected with a fan 62 to form an air flow in the main body 10.

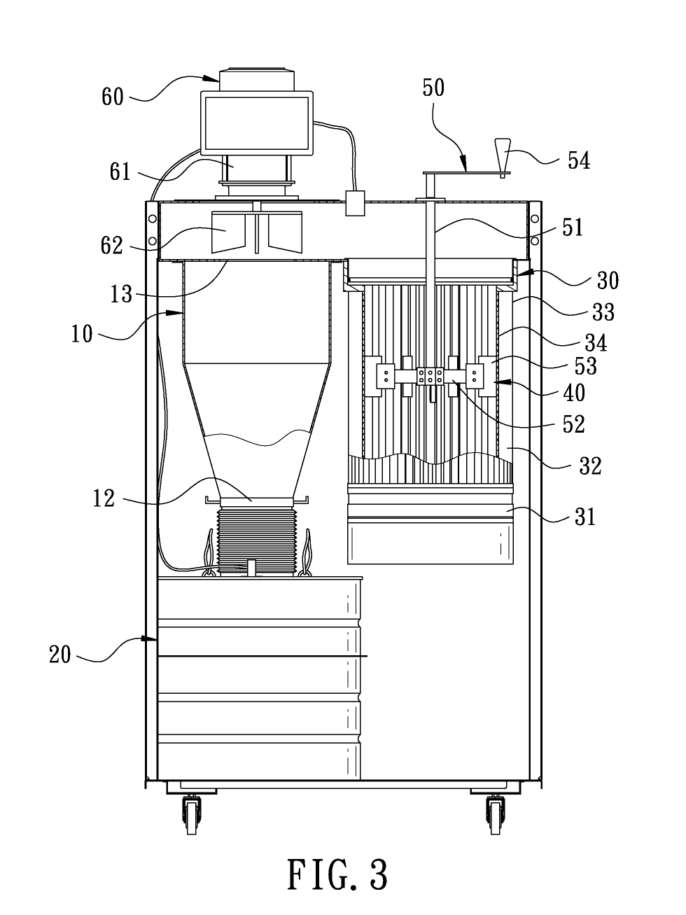

Referring to FIG. 2 and FIG. 3, the dust collection tube 200 is connected to the air inlet 11 of the main body 10. The airflow with dust is sucked into the main body 10 through the exhauster 60 for collecting dust. The heavy dust falls into the dust collection cylinder 20 due to gravity. The light dust is affected by the airflow and suck to the filter 30, so that the light dust is adsorbed to the inner wall of the filter 32 of the filter cylinder 30 to achieve the effect of filtering dust.

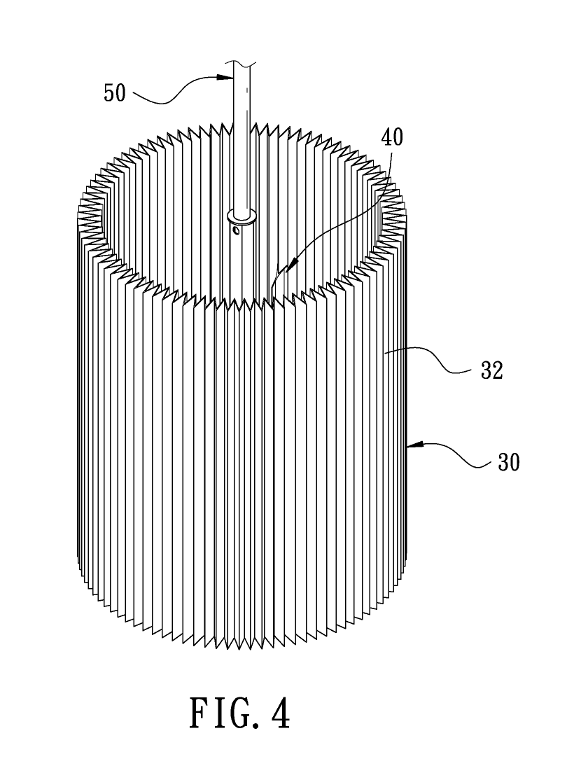

Referring to FIG. 4 to FIG. 7, the tab 40 is disposed on the inner wall of the filter 32. In this embodiment of the present invention, the inner wall of the filter 32 is provided with at least six tabs 40 evenly spaced and arranged annularly. The flap members 53 of the cleaning device 50 correspond in position to the tabs 40. Through the handle 54, the guide rod 51 and the flap members 53 are driven to rotate in the filter cylinder 30. When the flap members 53 are rotated, the flap members 53 will flap the tabs 40 to vibrate the tabs 40 and further to vibrate the filter 32, so that the dust adsorbed to the filter 32 drops from the filter 32, enabling the user to easily remove the dust of the filter 32.

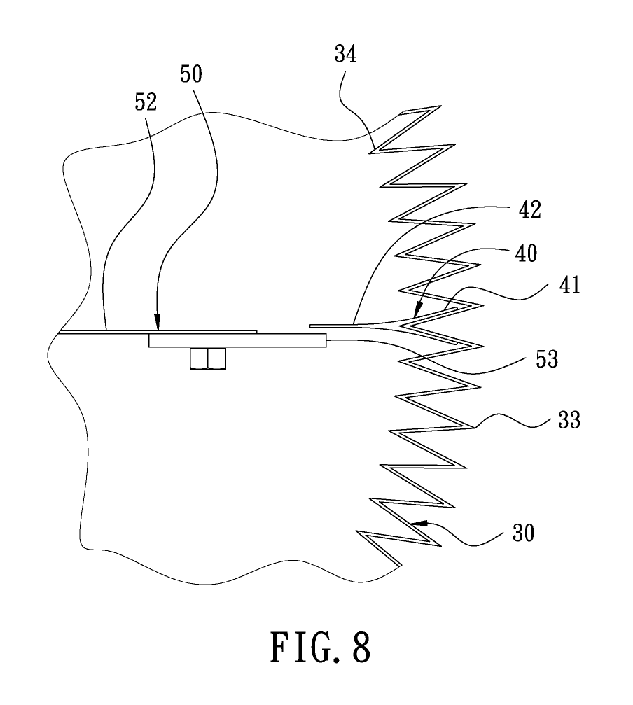

Referring to FIG. 8, the filter cylinder 30 is provided with the filter 32 which is able to filter out dust of PM2.5. The filtration film is attached to the inner peripheral wall of the filter 32. The inner peripheral wall of the filter 32 is formed with the zigzag tips 34 for increasing the area of the filter 32 to adsorb dust. The fixed portions 41 of the tabs 40 are fixed to the corresponding zigzag tips 34 of the filter 32 by bonding, respectively. In the embodiment of the present invention, the tab 40 is made of resilient anti-abrasive paper to enhance the structural strength of the filter 32, so that when the flap members 53 are rotated, the filtration film on the inner wall of the filter 32 won't be damaged, thereby prolonging the service life of the filter 32.

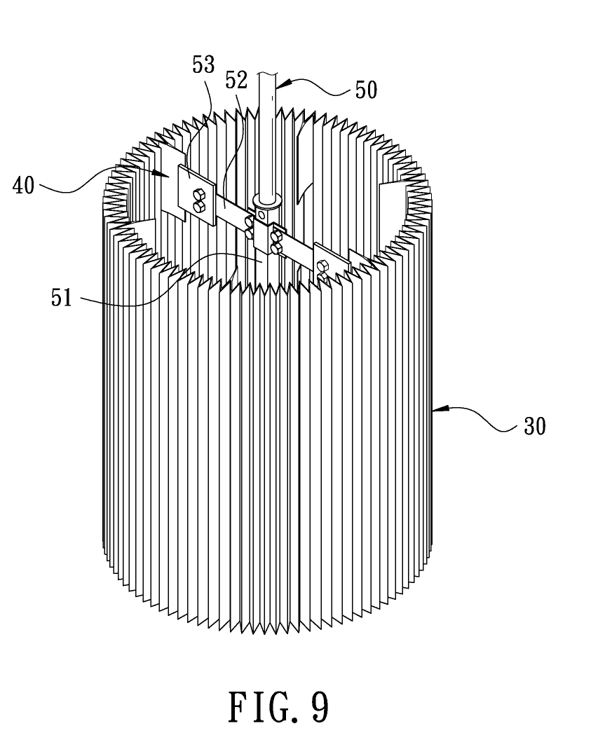

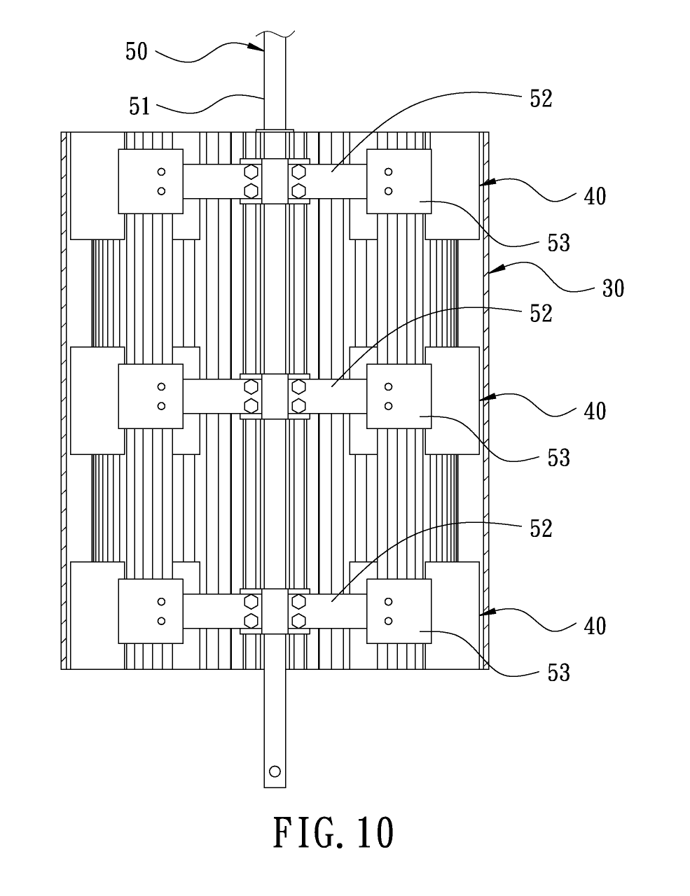

As shown in FIG. 9 and FIG. 10, the guide rod 51 of the cleaning device 50 is transversely provided with at least three brackets 52. The inner wall of the filter 32 is provided with a plurality of tabs 53 corresponding to the brackets 52. In the second embodiment of the present invention, the inner wall of the filter 32 is provided with at least six tabs 40 corresponding to each bracket 52 and evenly spaced and arranged annularly. When the cleaning member 50 is rotated in the filter cylinder 30, the flap members 53 will flap the tabs 40 to vibrate the filter 32, so that the dust adsorbed to the filter 32 drops from the filter 32. This can enhance the cleaning effect for the cleaning device 50 to clear the dust in the filter cylinder 30.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A filter cylinder having a dust cleaning device of a dust collector, the filter cylinder having a cylindrical outer frame, a high-efficiency particulate air (HEPA) filter being provided inside the filter cylinder, the filter being in the form of a cylinder, an outer peripheral wall of the filter being formed with a plurality of zigzag edges, an inner peripheral wall of the filter being formed with zigzag tips corresponding to the zigzag edges, a cleaning device being axially provided in the filter cylinder, the cleaning device including a main shaft, the main shaft being transversely provided with at least one bracket, two ends of the bracket being each provided with a flap member, an upper end of the main shaft being provided with a handle, the cleaning device being driven to rotate in the filter cylinder by the handle, characterized by that:
at least one tab disposed in the filter cylinder, one end of the tab having a fixed portion fixed to a corresponding one of the zigzag tips of the filter, another end of the tab having a movable portion extending toward the flap member to be in contact with the flap member;
wherein when the flap member is rotated, one end of the flap member flaps the movable portion of the tab to vibrate the filter so that dust adsorbed to the filter drops from the filter.

2. The filter cylinder having a dust cleaning device as claimed in claim 1, wherein the fixed portion of the tab has a Y-like shape to be fixed to a corresponding one of the zigzag tips of the filter.

3. The filter cylinder having a dust cleaning device as claimed in claim 1, wherein the fixed portion of the tab is fixed to the inner wall of the filter by bonding.

4. The filter cylinder having a dust cleaning device as claimed in claim 1, wherein the filter is capable of filtering out dust of PM2.5.
